(19) United States
(12) Patent Application Publication
(10) Pub. No.: US 2008/0248752 A1
(43) Pub. Date: Oct. 9, 2008

(54) RADIO TRANSMISSION SYSTEM, TRANSMITTER AND RADIO TRANSMISSION METHOD

(75) Inventor: Masahide ISHINO, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: NEC ACCESS TECHNICA, LTD., Shizuoka (JP)

(21) Appl. No.: 12/049,873

(22) Filed: Mar. 17, 2008

(30) Foreign Application Priority Data
Apr. 9, 2007 (JP) 101653-2007

(51) Int. Cl. H04B 17/00

(52) U.S. Cl. 455/62; 455/67.11

(57) ABSTRACT

A radio transmission system includes a transmitter and a receiver. The transmitter includes: first and second antennas; a transmission circuit converting an signal into a radio signal corresponding to a transmission channel, and transmitting the radio signal via a transmission antenna; a receiving circuit measuring an electric field strength, for each channel, of a radio wave which a receiving antenna receives; a control circuit selecting first antenna as the receiving antenna, selecting a channel which includes the smallest strength as the transmission channel, selecting first antenna as the transmission antenna when the largest strength is equal to or smaller than a threshold value, and selecting second antenna as the transmission antenna when the largest strength is larger than the threshold value; and a switching circuit connecting the transmission circuit and the receiving circuit to the antennas, according to the selection by the control circuit.

### INCORPORATION BY REFERENCE

This application is based upon and claims the benefit of priority from Japanese Patent Application No. 2007-101653, filed on Apr. 9, 2007, the disclosure of which is incorporated herein in its entirety by reference.

### BACKGROUND OF THE INVENTION

1. Technical Field

The present invention relates to a technology in which a signal is carried by a radio wave and, in particular, relates to a technology in which the signal inputted from the outside is converted to a radio signal within a predetermined frequency band and then transmitted.

2. Background Art

There are some apparatuses which convert a signal inputted from other apparatus into a radio signal within a predetermined frequency band and transmit the radio signal. For example, there is a transmitter which converts a video signal and an audio signal into a radio signal in a VHF band which a television set can receive and then, transmits the radio signal. The video and audio signals are inputted from an audio-visual apparatus (hereinafter, referred to as AV apparatus). A technology with regard to the transmitter is disclosed in, for example Japanese Patent Application No. 2006-258343. The transmitter disclosed in the document detects a frequency channel of which electric field strength is below a predetermined level out of all channels in a VHF band as an available channel, based on measurement by a receiving circuit. Then, the transmitter transmits the video signal and the audio signal via the available channels.

With regard to the technology for detecting an available radio channel, for example, Japanese Patent Application Laid-Open No. 2003-110475 discloses a technology for detecting the available radio channel in view of an interfering radio wave. According to the technology, a point (i.e. null point) where electric field strength of the interfering radio wave is weakest is searched for, and signals are transmitted via an antenna at the null point.

### SUMMARY

An exemplary object of the present invention is to provide a radio transmission system, a transmitter and a radio transmission method which can properly transmit a radio wave to a receiver, even in an environment where it is difficult for the radio wave transmitted from a transmitter to reach the receiver.

A radio transmission system according to an exemplary aspect of the invention includes a transmitter transmitting a radio signal and a receiver receiving the radio signal. The transmitter includes a first antenna, a second antenna, a transmission circuit which converts an inputted signal into the radio signal corresponding to a transmission channel in a predetermined frequency band and transmits the radio signal via a transmission antenna, a receiving circuit which measures an electric field strength, for each channel, of a radio wave received by a receiving antenna receives, a control circuit and a switching circuit. The control circuit selects the first antenna as the receiving antenna, detects the largest value and the smallest value out of the electric field strength, selects a channel which includes the smallest value of the electric field strength as the transmission channel, selects the first antenna as the transmission antenna when the largest value is equal to or smaller than a predetermined threshold value and selects the second antenna as the transmission antenna when the largest value is larger than the predetermined threshold value. The switching circuit connects the transmission circuit to one of the first antenna and the second antenna and connects the receiving circuit to one of the first antenna and the second antenna according to the selection by the control circuit.

A radio transmission method according to another exemplary aspect of the invention includes: selecting a receiving antenna; measuring electric field strength of a radio wave received by the receiving antenna receives, for each channel; detecting the largest value and the smallest value out of the measured electric field strength; selecting a channel including the smallest value of the electric field strength as a transmission channel; selecting the first antenna as a transmission antenna if the largest value is equal to or smaller than a predetermined threshold value, and selecting the second antenna as the transmission antenna if the largest value is larger than or equal to the predetermined threshold value; converting an inputted signal into a radio signal corresponding to the transmission channel; and transmitting the radio signal via the transmission antenna.

### BRIEF DESCRIPTION OF THE DRAWINGS

Exemplary features and advantages of the present invention will become apparent from the following detailed description when taken with the accompanying drawings in which:

FIG. 1 is a block diagram showing a system configuration of a video and audio transmission system according to a first exemplary embodiment to a fourth exemplary embodiment of the present invention;

FIG. 2 is a configuration diagram of the second switch according to the first to the fourth exemplary embodiments of the present invention;

FIG. 3 is a flowchart showing an operation of a transmitter according to the first exemplary embodiment of the present invention;

FIG. 4 is a block diagram showing a configuration which is requisite for a signal transmission system according to the first exemplary embodiment of the present invention;

FIG. 5 is a flowchart showing an operation of a transmitter according to the second exemplary embodiment of the present invention;

FIG. 6 is a flowchart showing an operation of a transmitter according to the third exemplary embodiment of the present invention;

FIG. 7 is a flowchart showing an operation of a transmitter according to the fourth exemplary embodiment of the present invention;

FIG. 8 is a block diagram showing a system configuration of an video and audio transmission system according to a fifth exemplary embodiment to an eighth exemplary embodiment of the present invention;

FIG. 9 is a flowchart showing an operation of a transmitter according to the fifth exemplary embodiment of the present invention;

FIG. 10 is a flowchart showing an operation of a transmitter according to the sixth exemplary embodiment of the present invention;

FIG. 11 is a flowchart showing an operation of a transmitter according to the seventh exemplary embodiment of the present invention;

FIG. 12 is a flowchart showing an operation of a transmitter according to the eighth exemplary embodiment of the present invention;

FIG. 13 is a block diagram showing a partly-modified system configuration of the video and audio transmission system of the fifth to the eighth exemplary embodiments of the present invention.

### EXEMPLARY EMBODIMENT

Exemplary embodiments of the present invention will now be described in detail in accordance with the accompanying drawings.

### 1. First Exemplary Embodiment

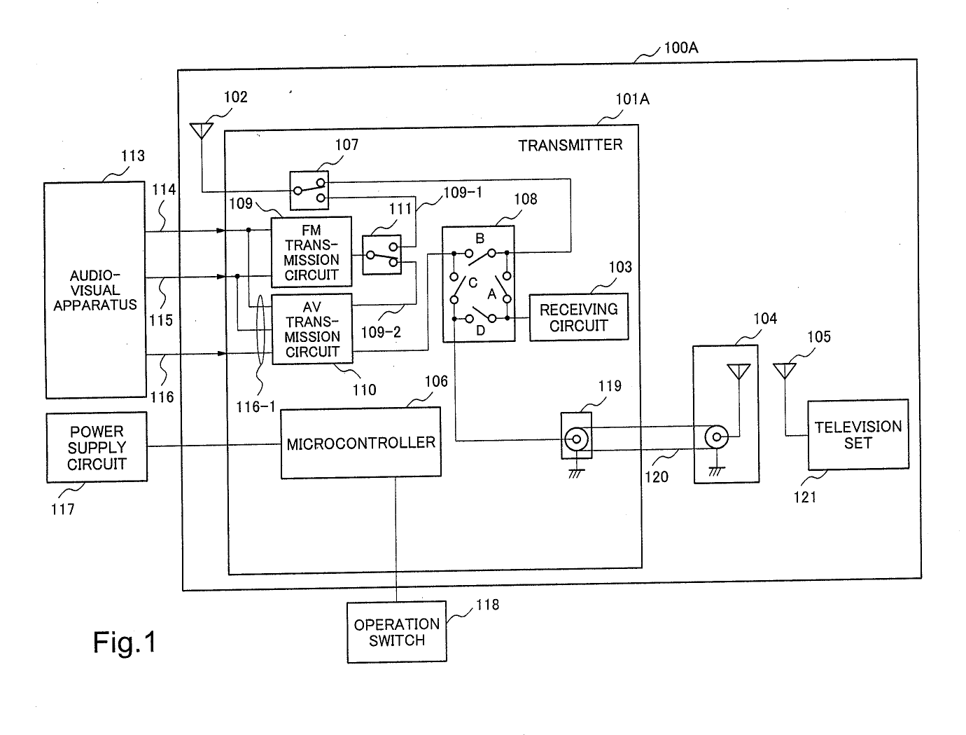

FIG. 1 shows a system configuration of a video and audio transmission system according to a first exemplary embodiment of the present invention. A video and audio transmission system 100A includes a transmitter 101A and a television set 121. The transmitter 101A converts a video signal and an audio signal inputted from an AV apparatus 113 into a television broadcasting radio signal, and transmits the radio signal. The television set 121 receives the radio signal via a receiving antenna 105 and regenerates the video signal and the audio signal.

The transmitter 101A includes a first antenna 102 and a second antenna 104 for transmitting and receiving the radio signal in a VHF band. The first antenna 102 is mounted outside the transmitter 101A according to FIG. 1. Alternatively, the first antenna 102 may be stored within the transmitter 101A as a built-in antenna. The second antenna 104 is arranged in the closer vicinity of the receiving antenna 105 in comparison with the first antenna 102. When the radio wave environment around the first antenna 102 is not suitable for the radio transmission due to an intense electric field near the first antenna 102, the second antenna 104 is used instead of the first antenna 102, as mentioned below. The second antenna 104 is detachably connected to an external antenna connector 119 via a coaxial cable 120. Alternatively, the second antenna 104 may be connected fixedly to the transmitter 101A.

Further, the transmitter 101A includes a receiving circuit 103, a FM transmission circuit 109, an audio-visual transmission circuit (hereinafter, referred as to AV transmission circuit) 110, a first switch 107, a second switch 108, a third switch 111 and a microcontroller 106. The microcontroller 106 is a control circuit of the transmitter 101A. A power supply circuit 117 and an operation switch 118 are arranged outside the video and audio transmission system 100A and connected to the transmitter 101A. The power supply circuit 117 and the operation switch 118 may be connected fixedly to the transmitter 101A and may be a component of the video and audio transmission system 100A.

The receiving circuit 103 measures electric field strength of a radio wave, which the first antenna 102 and the second antenna 104 receive, on a channel-by-channel basis for FM broadcasting and terrestrial television broadcasting.

The FM transmission circuit 109 frequency-modulates an R-ch audio signal 114 and an L-ch audio signal 115 inputted from the AV apparatus 113, and outputs a frequency-modulated signal 109-1. The FM transmission circuit 109 generates a local frequency signal 109-2 which the AV transmission circuit 110 uses.

The AV transmission circuit 110 converts the R-ch audio signal 114, the L-ch audio signal 115 and a video signal 116, which are outputted from the AV apparatus 113, into television broadcasting radio signals in a VHF band. The AV transmission circuit 110 may include an amplifier and may output amplified signals.

The first switch 107 switches destination to be connected of the first antenna 102 to the second switch 108 or the third switch 111. The second switch 108 controls the interconnections among the receiving circuit 103, the AV transmission circuit 110, the first switch 107 and the second antenna 104. Moreover, the third switch 111 switches destination to be connected of the FM transmission circuit 109 to the first switch 107 or the AV transmission circuit 110. The microcontroller 106 controls operations of a switch group including the first switch 107, the second switch 108 and third switch 111.

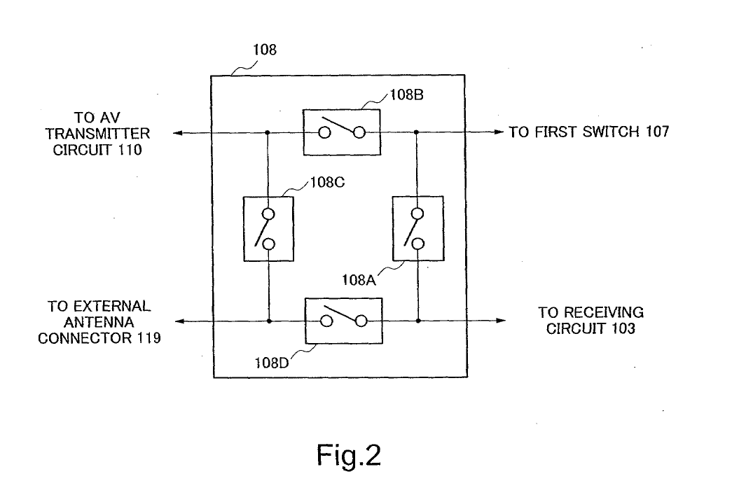

FIG. 2 shows an internal configuration of the second switch 108. A switch 108A connects and disconnects the first switch 107 with the receiving circuit 103. A switch 108B connects and disconnects the first switch 107 with the AV transmission circuit 110. A switch 108C connects and disconnects the AV transmission circuit 110 with the external antenna connector 119. A switch 108D connects and disconnects the external antenna connector 119 with the receiving circuit 103.

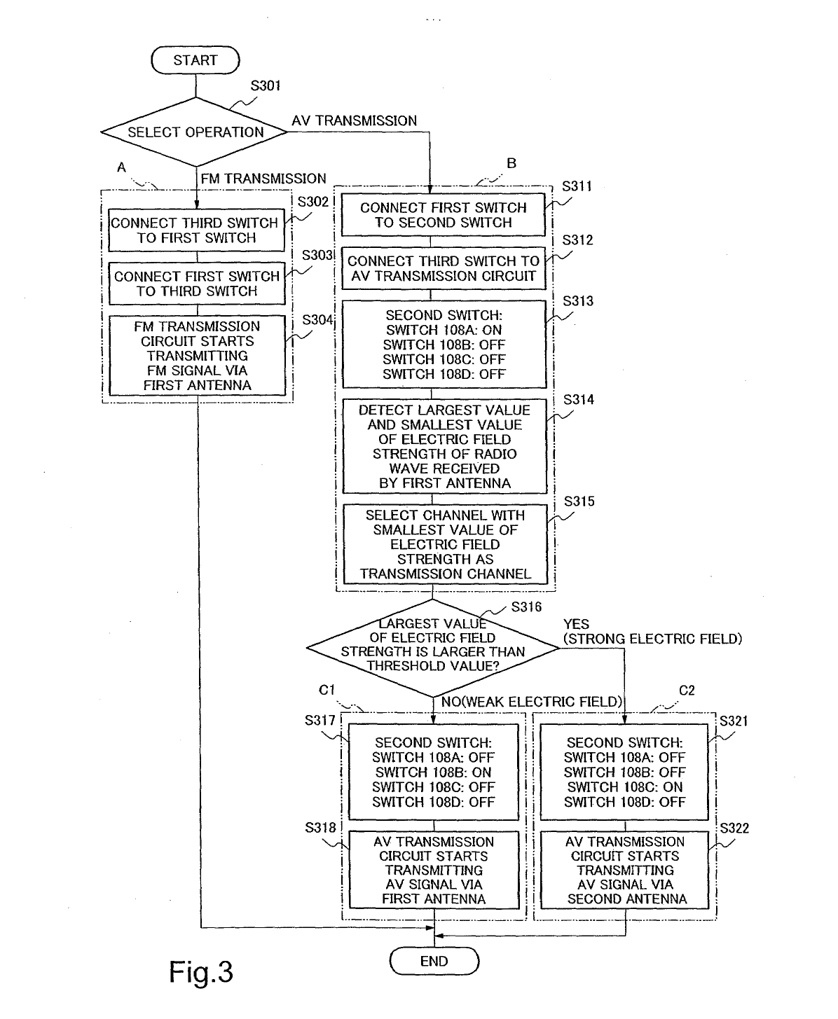

Operation of the first exemplary embodiment will be described in the following with reference to a flowchart shown in FIG. 3. First, according to intended purposes of the transmitter 101A, a user of the video and audio transmission system 100A selectively operates operation switch 118. Specifically, when the user wants to listen to a FM broadcasting program, the user selects an operation of “FM transmission”. Then, the transmitter 101A transmits the R-ch audio signal 114 and the L-ch audio signal 115 from the AV apparatus 113 to perform “FM transmission”. When the user wants to regenerate the audio signal and the video signal on the television set 121, the user selects an operation of “audio and video transmission (hereinafter, referred to as AV transmission)”. Then, the transmitter 101A transmits the R-ch audio signal 114, the L-ch audio signal 115 and the video signal 116 (hereinafter, these three signals are referred together to as an AV signal 116-1) inputted from the AV apparatus 113. The television set 121 receives the AV signal 116-1 and regenerates the video signal and the audio signal.

When the operation of “FM transmission” is selected (“FM transmission” in Step S301), steps in a frame-A in FIG. 3 (hereinafter, referred to as a process-A) are executed. That is, the microcontroller 106 connects the third switch 111 with the first switch 107 (Step S302) and connects the first switch 107 with the third switch 111 (Step S303). When the above mentioned connections are completed, the FM transmission circuit 109 begins FM transmission via the first antenna 102 (Step S304).

When the operation of “AV transmission” is selected (“AV transmission” in Step S301), steps in a frame B in FIG. 3 (hereinafter, referred to as a process-B) are executed. That is, the transmitter 101A measures electric field strength of a VHF band in the surrounding environment. In order to measure the strength, the microcontroller 106 connects the first switch 107 with the second switch 108 (Step S311) and connects the third switch 111 with the AV transmission circuit 110 side (Step S312) Furthermore, the microcontroller 106 turns on the switch 108A in the second switch 108, and turns off the other switches (108B, 108C and 108D) therein (Step S313). As a result, the receiving circuit 103 is connected with the first antenna 102.

Then, the receiving circuit 103 measures electric field strength of a VHF band radio wave received by the first antenna 102 for each channel therein. The microcontroller 106 detects the largest value and the smallest value of the electric field strength measured by the receiving circuit 103 and determines a channel which includes the largest value and also a channel which includes the smallest value according to the measured result (Step S314). Then, the microcontroller 106 selects the channel which includes the smallest value of the electric field strength as a transmission channel for the AV transmission (Step 315).

Next, the microcontroller 106 determines whether or not the largest value of the electric field strength is larger than a predetermined threshold value (Step S316). When the largest value is equal to or smaller than the predetermined threshold value (No at step S316), the microcontroller 106 judges that the surrounding environment lies under a weak electric field, that is, the surrounding environment is in a relatively good condition for radio transmission. Then, the microcontroller 106 executes steps in a frame C1 in FIG. 3 (hereinafter, referred to as a process-C1). That is, the microcontroller 106 turns on the switch 108B in the second switch 108, and turns off the other switches (108A, 108C and 108D) therein (Step S317). As a result, the AV signal converted into the television broadcasting radio wave signal by the AV transmission circuit 110 is transmitted via the first antenna 102 (Step S318).

In contrast, when the largest value of the electric field strength is larger than the predetermined threshold value (Yes at step S316), the microcontroller 106 judges that the surrounding environment lies under a strong electric field, that is, the surrounding environment is in a condition in which the radio transmission tends to suffer from noise interference. Then, the microcontroller 106 executes steps in a frame C2 in FIG. 3 (hereinafter, referred to as a process-C2). That is, the microcontroller 106 turns on the switch 108C in the second switch 108, and turns off the other switches (108A, 108B and 108D) therein (Step S321). As a result, the AV signal inputted from the AV transmission circuit 110 is transmitted through a coaxial cable 120 to the second antenna 104, which is arranged near the television set 121, and further transmitted from the second antenna 104 (Step S322).

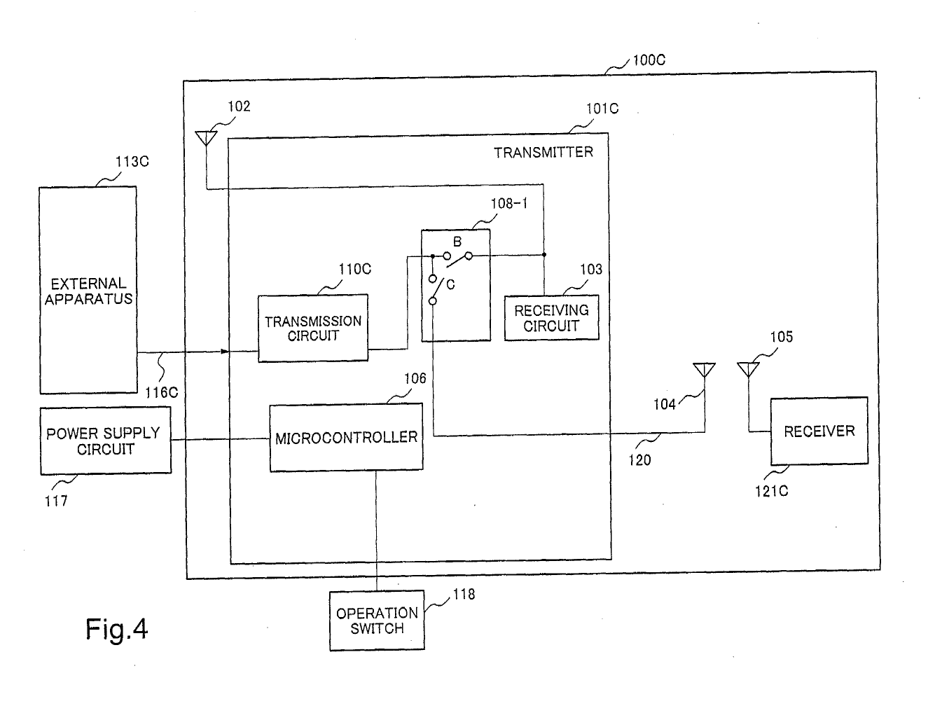

FIG. 4 indicates a minimum configuration required for building a signal transmission system according to the present invention. A signal transmission system 100C in FIG. 4 includes a transmitter 101C and a receiver 121C. The signal transmission system 100C has a simplified configuration of the video and audio transmission system 100A in FIG. 1. An external apparatus 113C which outputs a signal 116C may be an AV apparatus. The signal 116C is a general one and may include a video signal or an audio signal. The receiver may be a television system.

The transmitter 101C includes a transmission circuit 110C for transmitting the signal 116C to the receiver 121C, instead of the AV transmission circuit 110 in FIG. 1. FM transmission for audio signal is not performed and the FM transmission circuit 109 is omitted. The transmission circuit 110C generates the local frequency signal 109-2 in FIG. 1 internally. The transmission circuit 110C converts the signal 116C into a radio signal and transmits the radio signal to the receiver 121C. Therefore, the first switch 107 and the third switch 111 in FIG. 1 are also omitted, and the second switch 108 in FIG. 1 can be simplified like a second switch 108-1 in FIG. 4. As a second antenna 104 is directly connected with the transmitter 101C, the external antenna connector 119 in FIG. 1 is also omitted.

As mentioned above, a transmitter 101C in the minimum structure includes the transmission circuits 110C, the receiving circuit 103, the second switch 108-1 and the microcontroller 106. The signal transmission system of the present invention may be built by the minimum structure such as the signal transmission system 100C as shown in FIG. 4.

According to the first exemplary embodiment, when the surrounding environment lies under a strong electric field, an AV signal is transmitted via the second antenna 104 arranged near the television set 121. Therefore, the television set 121 can regenerate clear images and sounds despite the surrounding environment under a strong electric field. The AV signal is transmitted through a suitable channel selected based on measured values of electric field strength, and an antenna used for transmission is selected based on a condition of the surrounding electric field. Therefore, a transmitter which can be used in a strong electric field without highly increasing a transmission power can be provided.

### 2. Second Exemplary Embodiment

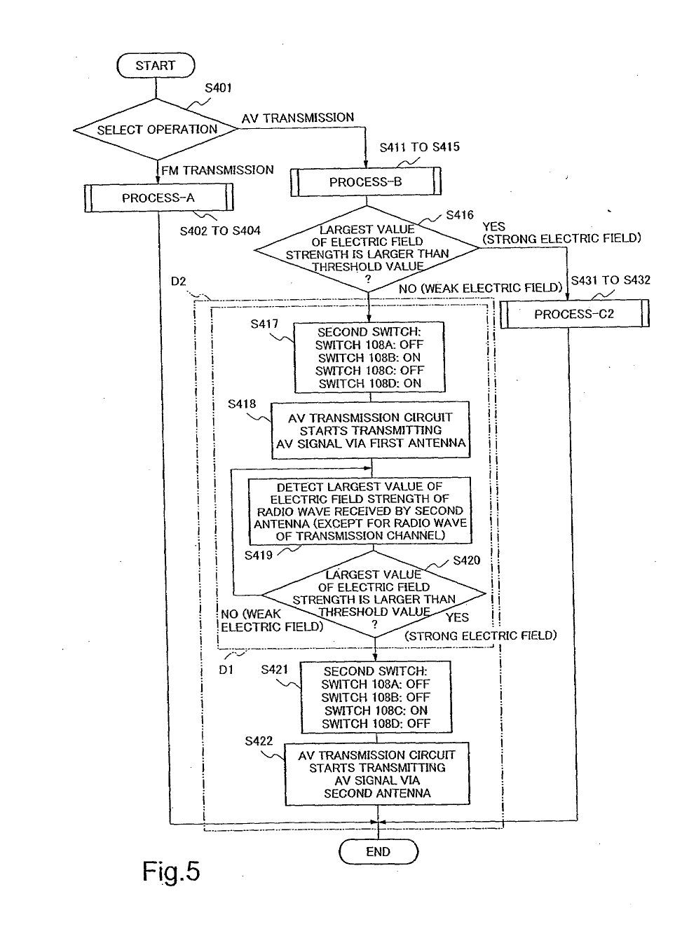

A second exemplary embodiment of the present invention will be described in the following with reference to a flowchart shown in FIG. 5. A system configuration of a video and audio transmission system according to the exemplary second embodiment is the same as one according to the first exemplary embodiment shown in FIG. 1.

When a user of the video and audio transmission system 100A selects an operation of “FM transmission” (“FM transmission” in step S401), the microcontroller 106 executes the process-A (Refer to steps S302 to S304 of FIG. 3) in the same way as the first embodiment (steps S402 to S404).

When the user selects an operation of “AV transmission” (“AV transmission” in step S401), the microcontroller 106 executes the process-B (Refer to steps S311 to S315 of FIG. 3) in the same way as the first exemplary embodiment (steps S411 to S415). As a result, a channel for the AV transmission is determined. The microcontroller 106 determines whether or not the largest value of the electric field strength is larger than a predetermined threshold value (Step S416). When the largest value of measured electric fields is larger than a predetermined threshold value (Yes at step S416), the microcontroller 106 judges that the surrounding environment lies under a strong electric field and then, executes the process-C2 (Refer to steps S321 to S322 of FIG. 3) in the same way as the first exemplary embodiment (steps S431 to S432). As a result, a radio wave including an AV signal is transmitted via the second antenna 104.

In contrast, when the largest value of the measured electric fields is equal to or smaller than the predetermined threshold value (No at step S416), the microcontroller 106 judges that the surrounding environment lies under a weak electric field. Then, the microcontroller 106 executes steps in a frame D1 shown in FIG. 5 (hereinafter, referred to as a process-D1). That is, the microcontroller 106 turns off the switch 108A and the switch 108C in the second switch 108, and turns on the switch 108B and the switch 108D (Step S417). The first switch 107 is connected with the second switch 108 side in S411 (step identical to step S311) in the process-B. Accordingly, the AV transmission circuit 110 and the first antenna are connected each other. As a result, the radio wave including the AV signal 116-1 the AV transmission circuit 110 outputs is transmitted via the first antenna 102 (Step S418).

Since the second switch 108D is turned on, the receiving circuit 103 is connected with the second antenna 104. While the AV signal 116-1 is transmitted via the first antenna 102, the transmitter 101A measures electric field strengths of a radio wave in VHF band, which the second antenna 104 receives, for each channel. Then, the microcontroller 106 detects the largest value out of measured electric fields of the channels except for an in-use transmission channel (Step S419), and determines whether or not the largest value is larger than a predetermined threshold value (Step S420).

When the largest value is equal to or smaller than the predetermined threshold value (No at step S420), the microcontroller 106 judges that the surrounding environment still lies under the weak electric field and consequently, continues transmitting the AV signal 116-1 via the first antenna 102 and measuring electric fields of the radio wave which the second antenna 104 receives.

When the largest value of the electric fields is larger than the predetermined threshold value (Yes at step S420), the microcontroller 106 judges that the surrounding environment becomes under a strong electric field from the weak electric field. In this case, the microcontroller 106 turns on the switch 108C in the second switch 108 and turns off the other switches (108A, 108B and 108D) in the second switch 108 (Step S421). As a result, the antenna which transmits the AV signal 116-1 is switched from the first antenna 102 (Step S422) to the second antenna 104 arranged near the television set 121.

Further, a set of processes from S417 to S422 is called a process-D2. The process-D2 corresponds to the process-D1 having additional processes of S421 and S422.

According to the second exemplary embodiment of the present invention, when the surrounding environment becomes under a strong electric field from a weak electric field, the AV signal is controlled to be transmitted via the second antenna 104. Accordingly, the television set can regenerate the video signal and the audio signal well, even under the strong electric field.

### 3. Third Exemplary Embodiment

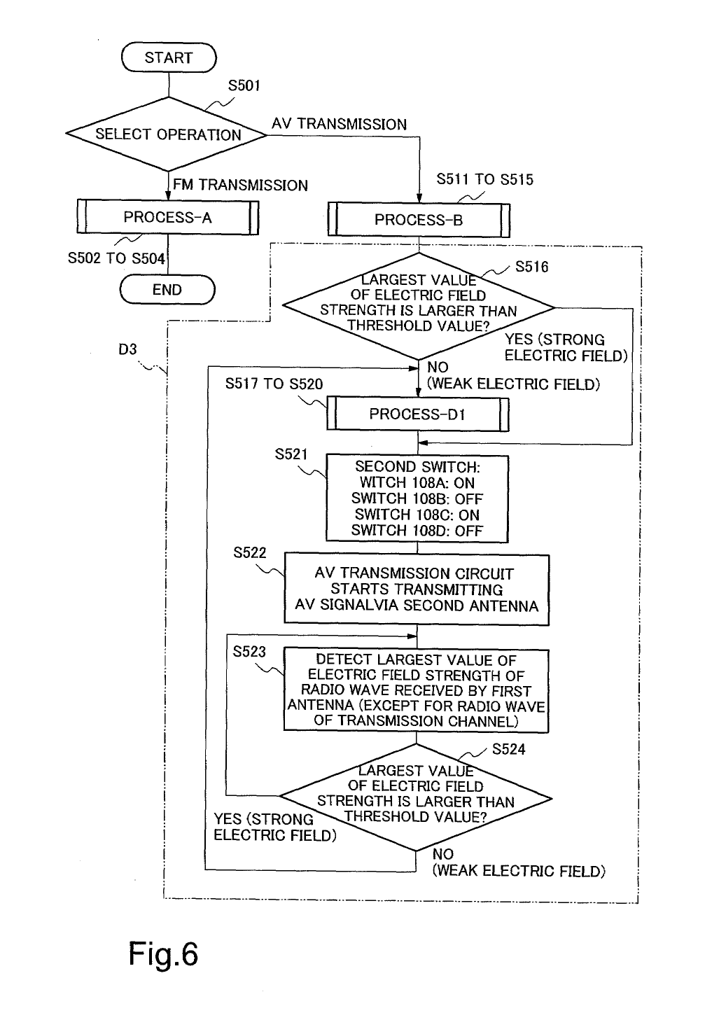

A third exemplary embodiment of the present invention will be described in the following with reference to a flowchart shown in FIG. 6. A system configuration of a video and audio transmission system of this embodiment is the same as one of the first and the second exemplary embodiments shown in FIG. 1.

When a user of the video and audio transmission system 100A selects an operation of “FM transmission” (“FM transmission” in step S501), the microcontroller 106 executes the process-A in the same way as the first exemplary embodiment (Steps S502 to S504). When the user selects the operation of “AV transmission” (“AV transmission” in step S501), the microcontroller 106 executes the process-B in the same way as the first exemplary embodiment (Steps S511 to S515). As a result, a channel for transmitting the AV signal is determined.

The microcontroller 106 determines whether or not the largest value of the electric field strength is larger than a predetermined threshold value (Step S516). When the largest value of measured electric fields is equal to or smaller than the predetermined threshold value (No at step S516), the microcontroller 106 judges that the surrounding environment lies under a weak electric field and then, executes the process-D1 in the same way as the second exemplary embodiment (Steps S517 to S520). Then, the AV signal is transmitted via the first antenna 102 and electric fields of the radio wave which the second antenna 104 receives are measured.

In contrast, when the largest value of the electric fields is larger than the predetermined threshold value, the microcontroller 106 judges that the surrounding environment becomes under a strong electric field from the weak electric field in the process-D1. In such case, the microcontroller 106 turns on the switch 108A and the switch 108C in the second switch 108 and turns off the switch 108B and the switch 108D in the second switch 108 (Step S521). As a result, the antenna which transmits the AV signal is switched from the first antenna 102 to the second antenna 104 arranged near the television set 121 (Step S522).

While the AV signal is transmitted via the second antenna 104, the transmitter 101A measures electric fields of the VHF band radio wave, which the first antenna 102 receives, for each channel. Then, the microcontroller 106 detects the largest value out of measured electric fields except for the electric field of the in-use channel for the transmission (Step S523) and determines whether or not the detected largest value is larger than the predetermined threshold value (Step S524).

When the largest value is equal to or smaller than the predetermined threshold value (No at step S524) in the above-mentioned determination, the microcontroller 106 judges that the surrounding environment becomes under a weak electric field from the strong electric field and then, executes the above-mentioned process-D1 (Steps S517 to S520). As a result, the antenna which transmits the AV signal is switched from the second antenna 104 to the first antenna 102.

In contrast, when the largest value of the electric fields of the radio wave, which the first antenna 102 receives, is larger than the predetermined threshold value (Yes at step S524), the microcontroller 106 judges that the surrounding environment still lies under a strong electric field. The transmitter 101A continues transmitting the AV signal via the second antenna 104 and measuring the electric fields of the radio wave which the first antenna 102 receives.

A set of processes from S518 to S524 is called a process-D3. The processing D3 corresponds to the process-D1 having an additional step S516 before the process-D1, and having additional steps of S521 to S524 after the process-D1.

According to the third exemplary embodiment of the present invention, while an AV signal is transmitted via an antenna, a radio wave is received via another antenna and electric fields of the surrounding environment is checked. Accordingly, even in an environment in which electric field strength changes frequently, it is possible for a system to cope with the change appropriately.

### 4. Fourth Exemplary Embodiment

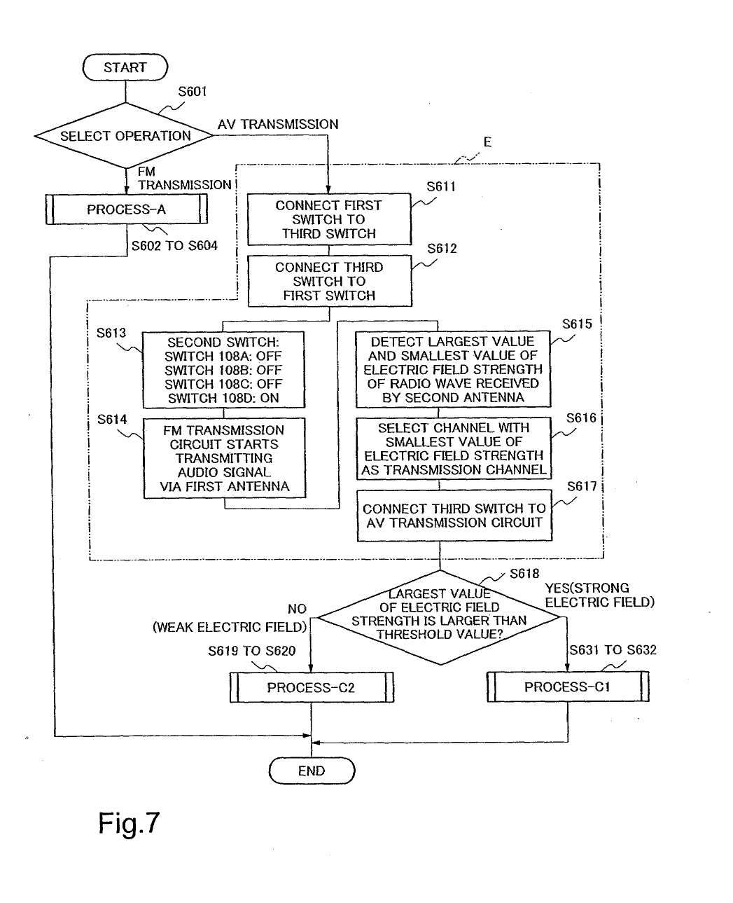

A fourth exemplary embodiment of the present invention will be described in the following with reference to FIG. 7. A system configuration of a video and audio transmission system according to the fourth exemplary embodiment is the same as one of first to third exemplary embodiments shown in FIG. 1. According to the fourth exemplary embodiment, electric fields are measured using an audio signal which a FM transmission circuit 109 outputs.

When a user of the video and audio transmission system 100A selects an operation of “FM transmission” (“FM transmission” in Step S601), the microcontroller 106 executes the process-A in the same way as the first exemplary embodiment (Steps S602 to S604).

When the user selects an operation of “AV transmission” (“AV transmission” in step S601), the microcontroller 106 connects the first switch 107 with the third switch 111 side and connects the third switch 111 with the first switch 107 side (Steps S611 and S612). As a result, the FM transmission circuit 109 is connected with the first switch 107. The microcontroller 106 turns on the switch 108D in the second switch 108 and turns off the other switches (108A, 108B and 108C) in the second switch 108 (Step S613). As a result, the receiving circuit 103 is connected with the second antenna 104.

According to connections above-mentioned, an output signal of the FM transmission circuit 109 is transmitted via the first antenna 102 (Step S614). The signal which the FM transmission circuit 109 outputs is used for measuring electric fields in the surrounding environment. Specifically, the output signal of the FM transmission circuit 109 corresponds to an audio signal for each channel of television broadcasting radio wave. When the FM transmitting circuit 109 outputs the audio signal, the FM transmission circuit 109, for example, may generate audio signals corresponding to each channel frequency, based on a reference frequency signal of nearly 1 KHz which is supplied by an oscillator (un-illustrated). Information on the channel frequencies, output timing of the audio signal, or the like are supplied by the microcontroller 106.

As another method in which the FM transmission circuit 109 outputs the audio signal, the FM transmission circuit 109 may use the audio signal (R-ch audio signal 114 or L-ch audio signal 115) supplied by the AV apparatus 113 instead of the above-mentioned reference frequency signal supplied by the oscillator. In this case, the audio signal is outputted by the AV apparatus 113 according to the user operation, and the FM transmission circuit 109, which receives the audio signal from the AV apparatus 113, outputs a modulated audio signal whose carrier wave has a frequency corresponding to a channel in television broadcasting radio wave. That is, the FM transmission circuit 109 outputs the modulated audio signal based on the signal outputted by the AV apparatus 113.

While the transmitter 101A transmits the modulated audio signal 109-1, which the FM transmission circuit 109 outputs, via the first antenna 102 with the above-mentioned method, the receiving circuit 103 receives a radio wave via the second antenna 104. Then, the largest and the smallest values of the electric field in the received radio wave are detected (Step S615). The channel which includes the smallest value of the electric fields in the received radio wave is selected as a transmission channel (Step S616). When the selection of the transmission channel is completed, the microcontroller 106 connects the third switch 111 with the AV transmission circuit 110 (Step S617). A set of steps of S611 to S617 is called a process-E.

Afterward, the microcontroller 106 determines whether or not the detected largest value out of measured electric fields in the received radio wave via the second antenna 104 is larger than a predetermined threshold value (Step S618). When the largest value of the electric fields is equal to or smaller than the predetermined threshold value according to the determination process (No at step S618), the microcontroller 106 judges that it is difficult for the radio wave transmitted by the transmitter 101A to reach the television set 121. In such case, the microcontroller 106 executes the above-mentioned process-C2 (FIG. 3) (Steps S619 to S620). As a result, the radio signal including the AV signal is transmitted via the second antenna 104 arranged near the television set 121.

When the largest value of the electric fields in the received radio wave via the second antenna 104 is larger than the predetermined threshold value (Yes at step S618), the microcontroller 106 judges that the radio wave transmitted by the transmitter 101A easily reaches the television set 121. In this case, the microcontroller 106 executes the above-mentioned process-C1 (Steps S631-S632). As a result, the radio wave including the AV signal is transmitted via the first antenna 102.

According to the fourth exemplary embodiment, the audio signal outputted by the FM transmission circuit 109 is used for the measurement of the electric field. Accordingly, even in the environment in which it is difficult to receive a radio wave for television broadcasting in a VHF band, it is possible to measure an environment condition for receiving the radio wave.

### 5. Fifth Exemplary Embodiment

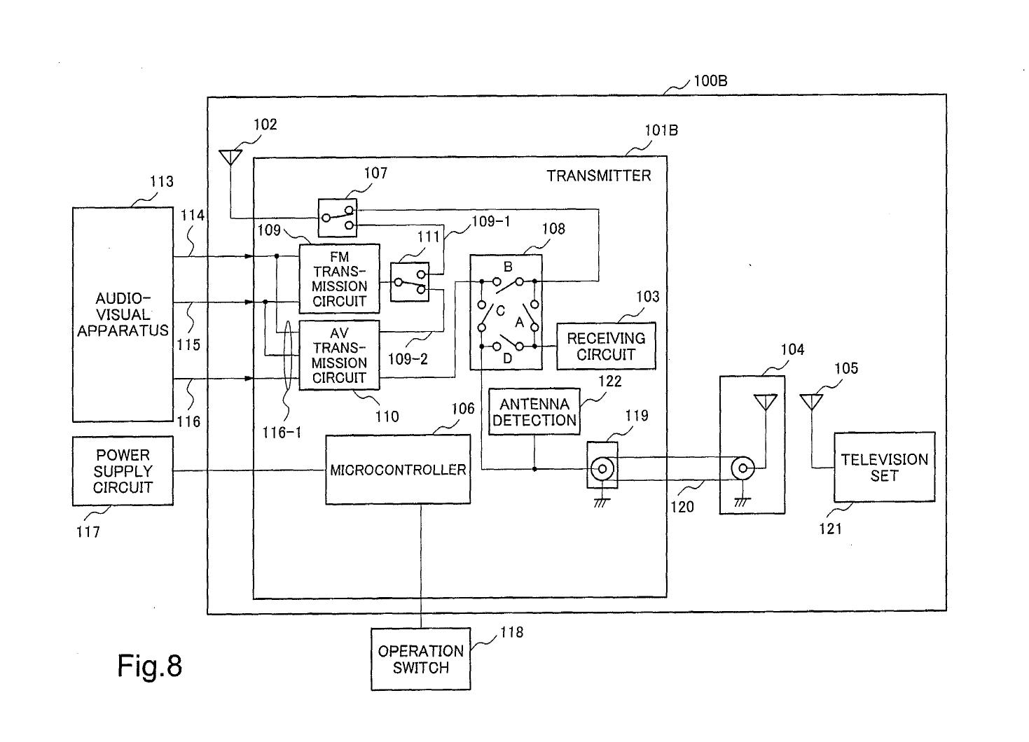

A system configuration of a video and audio transmission system according to a fifth exemplary embodiment of the present invention is shown in FIG. 8. In the configuration of a video and audio transmission system 100B, an antenna detection circuit 122 is added to the configuration of the first to the fourth exemplary embodiments shown in FIG. 1. In FIG. 8, the antenna detection circuit 122 is connected with a signal line between the external antenna connector 119 and the second switch 108. A transmitter 101B detects by the antenna detection circuit 122 whether or not the second antenna 104 is connected to the transmitter 101B.

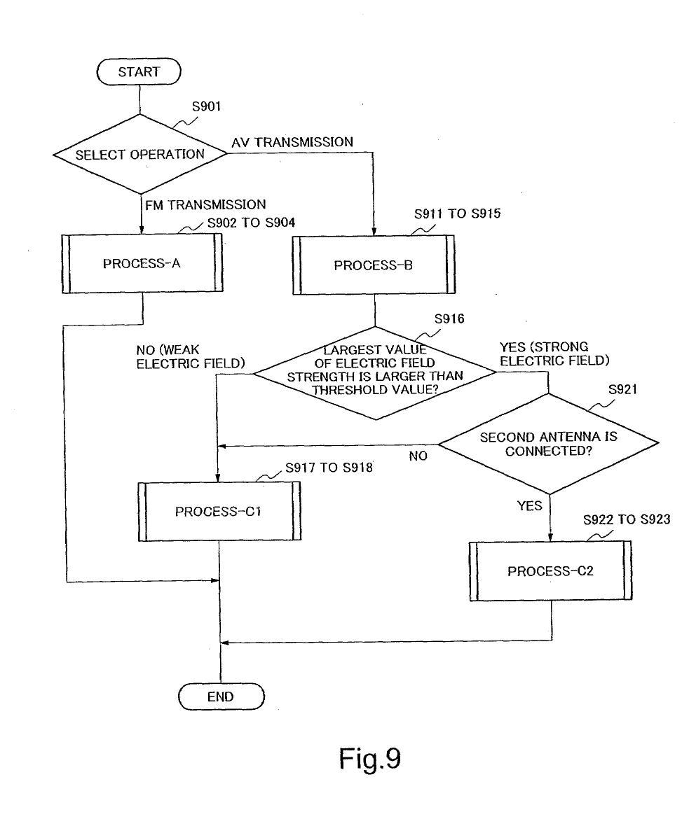

Operation of the fifth exemplary embodiment will be described in the following with reference to a flowchart shown in FIG. 9. In the operation of the fifth exemplary embodiment, a process according to the presence of the second antenna 104 is added to the operation of the first exemplary embodiment shown in FIG. 3.

When a user of the video and audio transmission system 100B selects an operation of “FM transmission” (“FM transmission” in step S901), the microcontroller 106 executes the process-A in the same way as the first embodiment (Steps S902 to S904). When the user selects an operation of “AV transmission” (“AV transmission” in step S901), the microcontroller 106 executes the process-B in the same way as the first embodiment (Steps S911 to S915). As a result, a channel for the transmission of the AV signal is determined.

The microcontroller 106 determines whether or not the largest value of the electric field strength is larger than a predetermined threshold value (Step S916). When the largest value of measured electric fields is equal to or smaller than a predetermined threshold value (No at step S916), the microcontroller 106 judges that the surrounding environment lies under a weak electric field and then, executes the process-C1 in the same way as the first exemplary embodiment (Steps S917 to S918). As a result, a radio wave including an AV signal is transmitted via the first antenna 102.

In contrast, when the largest value of the measured electric fields is larger than the predetermined threshold value (Yes at step S916), the microcontroller 106 judges that the surrounding environment lies under a strong electric field. At this time, the microcontroller 106 judges, using the antenna detection circuit 122, whether or not the second antenna 104 is connected with the transmitter 101B (Step S921). When it is judged that the second antenna 104 is not connected (No at step S921), the process-C1 is performed, that is, the AV signal is transmitted via the first antenna 102.

In contrast, when it is judged that the second antenna 104 is connected with the transmitter 101B and the surrounding environment is under a strong electric field (Yes at step S921), the microcontroller 106 executes the process-C2 in the same way as the first exemplary embodiment (Steps S922 to S923). As a result, a radio wave including the AV signal is transmitted via the second antenna 104.

According to the fifth exemplary embodiment, before the AV signal is transmitted, the presence of the second antenna 104 is detected. Accordingly, even if the second antenna 104 is not connected with the transmitter 101B, the AV signal can be transmitted via the first antenna 102.

### 6. Sixth Exemplary Embodiment

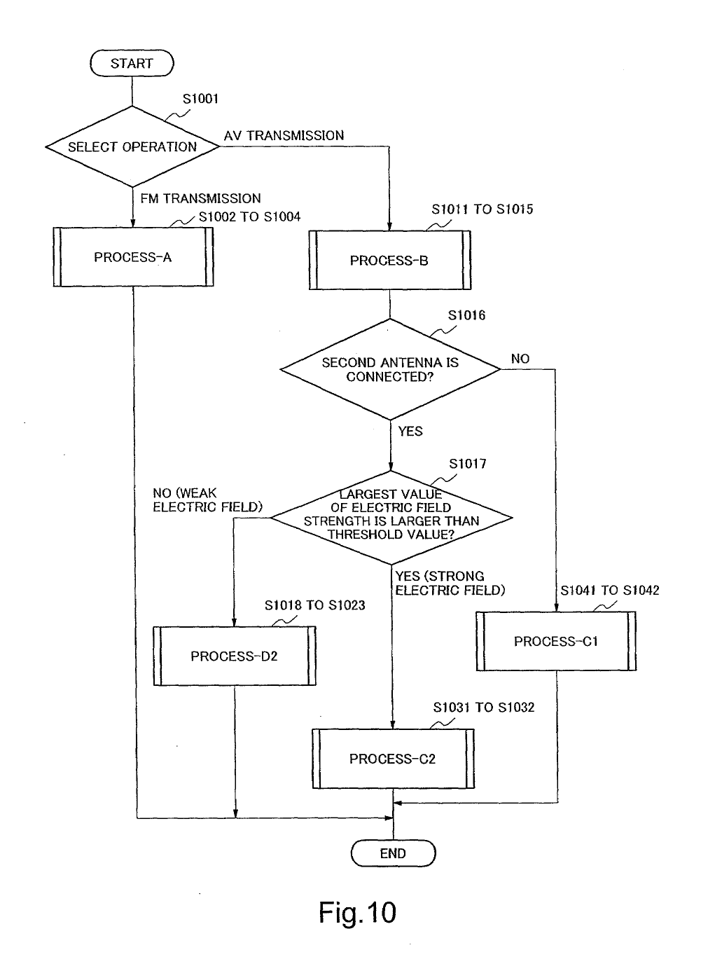

A sixth exemplary embodiment of the present invention will be described in the following with reference to a flowchart shown in FIG. 10. A system configuration of a video and audio transmission system of the sixth exemplary embodiment is same as the video and audio transmission system 100B of the fifth exemplary embodiment shown in FIG. 8. An operation of the sixth exemplary embodiment corresponds to an operation of the second embodiment shown in FIG. 5 having an additional control process according to the presence of the second antenna 104.

When a user of the video and audio transmission system 100B selects an operation of “FM transmission” (“FM transmission” in step S1001), the microcontroller 106 executes the process-A in the same way as the second exemplary embodiment (Steps S1002 to S1004). When the user selects an operation of “AV transmission” (“AV transmission” in step S1001), the microcontroller 106 executes the process-B in the same way as the second embodiment (Steps S1011 to S1015). As a result, a channel for transmission of an AV signal is determined.

Afterward, the microcontroller 106 judges whether or not the second antenna 104 is connected with the transmitter 101B (Step S1016). When it is judged that the second antenna 104 is not connected (No at step S1016), the microcontroller 106 executes the process-C1 shown in FIG. 3, that is, the transmitter 101B transmits the AV signal via the first antenna 102 (Steps S1041 to S1042).

When it is judged that the second antenna 104 is connected with the transmitter 101B (Yes at step S1016), the microcontroller 106 determines whether or not the largest value of measured electric fields is larger than a predetermined threshold value (Step S1017). When the largest value of the measured electric fields is equal to or smaller than the predetermined threshold value (No at step S1017), the microcontroller 106 judges that the surrounding environment lies under a weak electric field and then, executes the process-D2 in the same way as the second exemplary embodiment (Steps S1018 to S1023). As a result, a radio wave including the AV signal is transmitted via the first antenna 102. When the surrounding environment becomes under a strong electric field from the weak electric field afterward, the AV signal is transmitted via the second antenna 104.

When the largest value of the electric fields is larger than the predetermined threshold value (Yes at step S1017), the microcontroller 106 judges that the surrounding environment lies under a strong electric field and then, executes the process-C2 in the same way as the second exemplary embodiment (Steps S1031 to S1032). As a result, the radio wave including the AV signal is transmitted via the second antenna 104.

According to the sixth exemplary embodiment, the same process as the second exemplary embodiment is executed, and then, the presence of the second antenna 104 is checked before the AV signal is transmitted. Accordingly, even when the second antenna 104 is not connected to the transmitter 101B according to the second exemplary embodiment, the AV signal can be transmitted via the first antenna 102.

### 7. Seventh Exemplary Embodiment

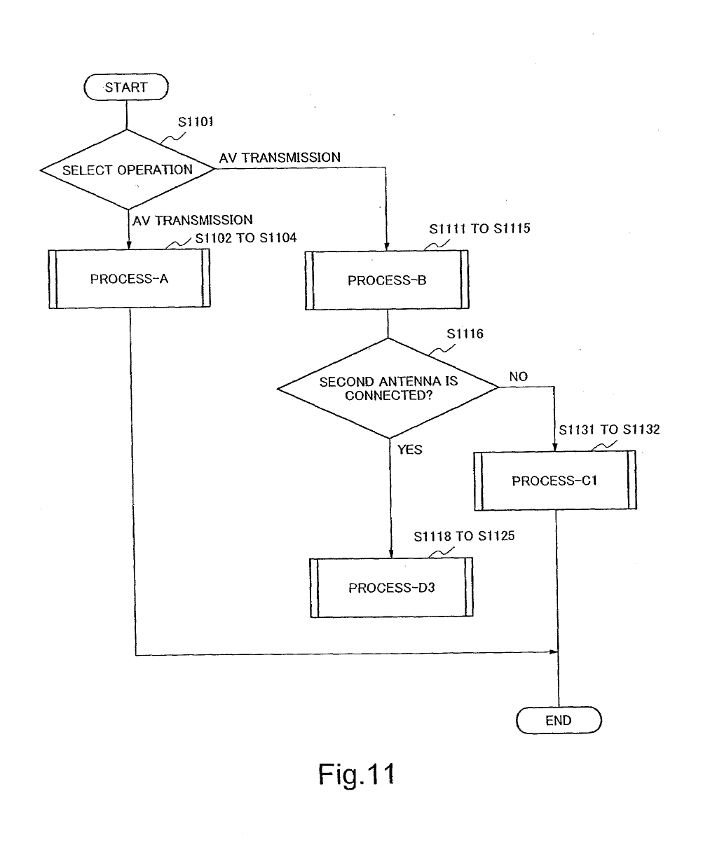

A seventh exemplary embodiment of the present invention will be described in the following with reference to a flowchart shown in FIG. 11. A system configuration of a video and audio transmission system according to the seventh exemplary embodiment is same as the video and audio transmission system 100B of fifth and sixth exemplary embodiments shown in FIG. 8. An operation of the seventh exemplary embodiment corresponds to an operation of the third exemplary embodiment shown in FIG. 6 having an additional control process according to the presence of the second antenna 104.

When a user of the video and audio transmission system 100B selects an operation of “FM transmission” (“FM transmission” in step S1101), the microcontroller 106 executes the same process-A as above-mentioned Steps S302 to S304 (FIG. 3) (Steps S1102 to S1104). When the user selects an operation of “AV transmission” (“AV transmission” in step S1101), the microcontroller 106 executes the same process-B as the above-mentioned Steps S311 to S315 (FIG. 3) (Steps S1111 to S1115). As a result, a channel for transmission of an AV signal is determined.

Afterward, the microcontroller 106 determines whether or not the second antenna 104 is connected therewith (Step S1116). When the second antenna is not connected with the transmitter 101B (No at step S1116), the microcontroller 106 executes the same process-C1 as above-mentioned steps S317 and S318 (FIG. 3) to transmit the AV signal via the first antenna 102 (Steps S1131 to S1132).

When the second antenna 104 is connected with the transmitter 101B (Yes at step S1116), the microcontroller 106 executes the same process-D3 (Steps S1118 to S1125) as the above-mentioned Steps S516 to S524 (FIG. 6) in which one of the antenna 102 and the antenna 104 is selected for the transmission of the AV signal in accordance with an electric field strength of the surrounding environment.

According to the seventh exemplary embodiment, the same process as the third exemplary embodiment is executed, and the presence of the second antenna 104 is checked before the AV signal is transmitted. As a result, even when the second antenna 104 is not connected to the system disclosed in the third exemplary embodiment, an AV signal can be transmitted via the first antenna 102.

### 8. Eighth Exemplary Embodiment

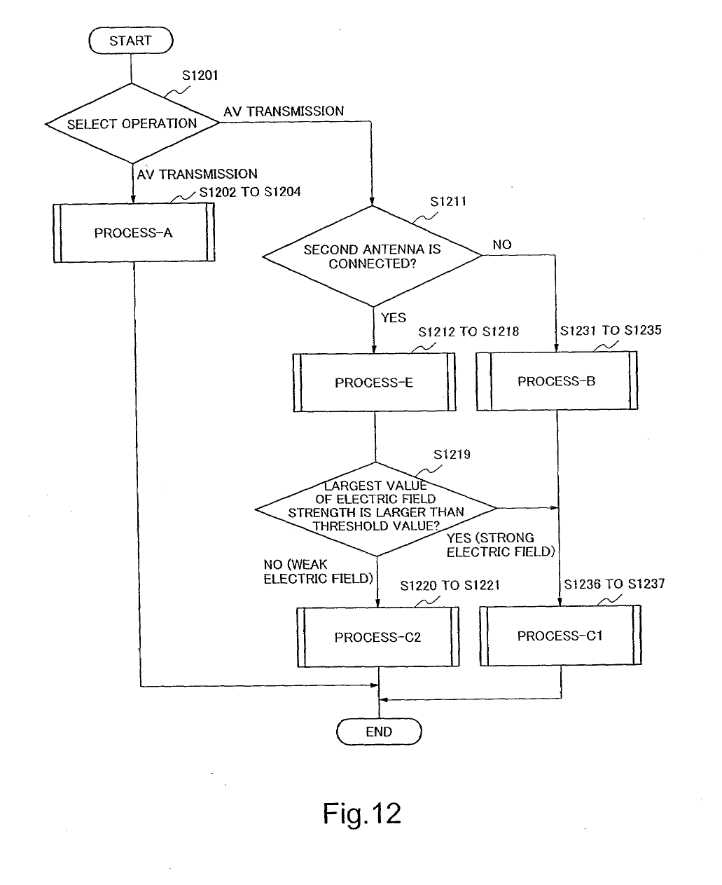

An eighth exemplary embodiment of the present invention will be described in the following with reference to a flowchart shown in FIG. 12. A system configuration of an video and audio transmission system of the eighth exemplary embodiment is same as the video and audio transmission system 100B of the fifth to the seventh exemplary embodiments shown in FIG. 8. An operation of the exemplary embodiment corresponds to an operation of the above-mentioned fourth exemplary embodiment shown in FIG. 7 having an additional control process according to the presence of the second antenna 104.

When a user of the video and audio transmission system 100B selects an operation of “FM transmission” (“FM transmission” in step S1201), the microcontroller 106 executes the same process-A (Steps S1202 to S1204) as the above-mentioned steps S302 to S304 (FIG. 3). When the user selects an operation of “AV transmission” (“AV transmission” in step S1201), the microcontroller 106 judges whether or not the second antenna 104 is connected therewith (Step S1211).

When the second antenna 104 is not connected with the transmitter 101B (No at step S1211), the microcontroller 106 executes the same process-B as above-mentioned steps S311 to S315 (FIG. 3) to determine a channel for transmission of an AV signal using a radio wave received by the first antenna 102 (Steps S1231 to S1235). The above-mentioned process-C1 (FIG. 3) is executed after completion of the process-B (Steps S1236 to S1237). In contrast, when the second antenna 104 is connected with the transmitter 101B (Yes at step S1211), the same process-E (Steps S1212-S1218) as the above-mentioned steps S611 to S617 to determine a transmission channel through using a audio signal for the measurement which is transmitted via the first antenna 102 and received via the second antenna 104 is executed.

The microcontroller 106 determines whether or not the largest value of measured electric fields is larger than a predetermined threshold value (Step S1219). When the largest electric field is equal to or smaller than the predetermined threshold value (No at step S1219), the microcontroller 106 judges that the surrounding environment is under a condition that the radio wave transmitted by the transmitter 101B can not reach easily the television set 121 and then, executes the above-mentioned process-C2 (FIG. 3) (Steps S1220 to S1221). As a result, the radio wave including the AV signal is transmitted via the first antenna 102.

When the largest electric field strength is larger than the predetermined threshold value (Yes at step S1219), the microcontroller 106 judges that the surrounding environment is under a condition that the radio wave transmitted by the transmitter 101B can reach easily the television set 121 and then, executes the above-mentioned process-C1 shown in FIG. 3 (Steps S1236 to S1237). As a result, the radio wave of the AV signal is transmitted via the second antenna 104.

According to the eighth exemplary embodiment, the microcontroller 106 executes the same process as the fourth exemplary embodiment and then, detects the presence of the second antenna 104 before transmitting the AV signal. Accordingly, even when the second antenna 104 is not connected to the system of the fourth exemplary embodiment, the video voice signal can be transmitted via the first antenna 102.

Further, the transmitter 101B shown in FIG. 8 can include a means for notifying a user of the video and audio transmission system 100B of the presence of the second antenna 104. The example of the means may include a display device such as a LED (Light Emitting Diode), a LCD (Liquid Crystal Display) and an EL (Electro Luminescence) display or a sound device such as a buzzer.

According to the first to the eighth exemplary embodiments, the second antenna 104 is arranged near the television set 121 so that the television set 121 can receive a radio wave transmitted by the transmitter 101A or the transmitter 101B in good condition. Other method may be used for this purpose.

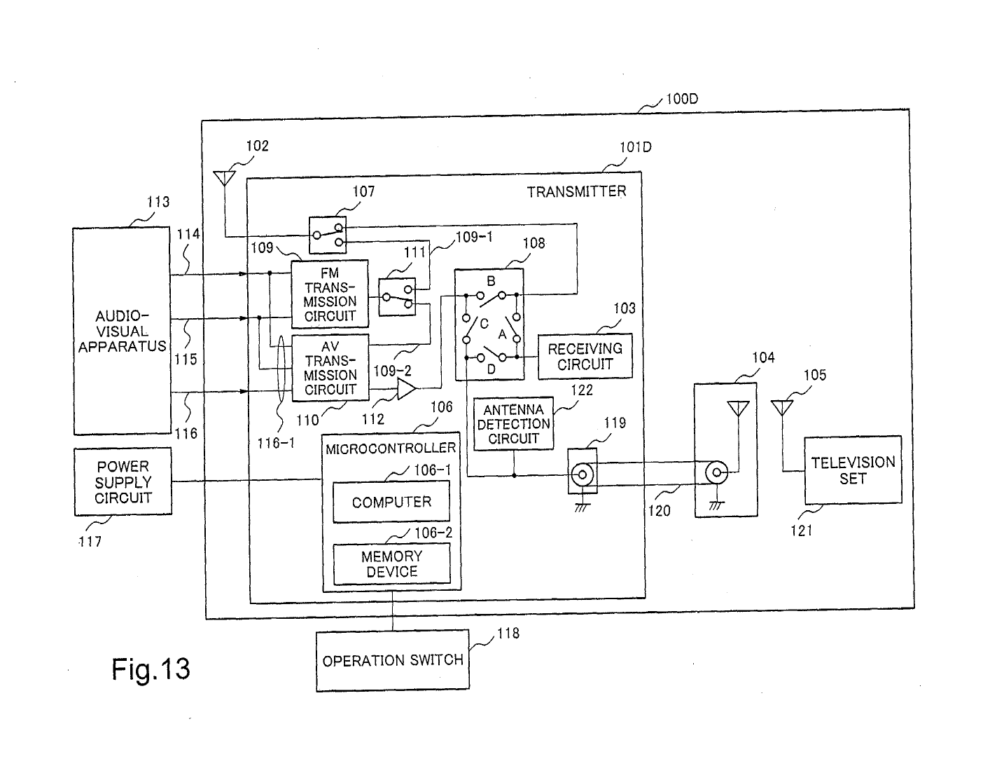

For example, an output signal of the AV transmission circuit 110 may be amplified in order to transmit an AV signal via the second antenna 104. FIG. 13 shows an video and audio transmission system 100D in which the systems of the fifth to the eighth exemplary embodiments shown in FIG. 8 further includes a amplifier 112 with a variable amplification gain function. A transmitter 101D includes the amplifier 112 arranged between the AV transmission circuit 110 and the second switch 108. The microcontroller 106 controls an amplification gain of the amplifier 112 to output a signal with a level which is larger than a level of the output signal transmitted from the first antenna 102. An output level of the transmitter 101D is controlled not to exceed the largest level set in advance in the transmitter, for example, the largest power level according to regulations. According to the method, the second antenna does not have to be arranged near the television set.

The microcontroller 106 in the transmitter 101D may include a computer 106-1 and a memory device 106-2. The operation of the transmitter 101D is controlled through the computer 106-1 reading a program from the memory device 106-2 and executing the program.

When the second antenna is not connected with the transmitter and an AV signal is transmitted via the first antenna under the environment having a strong electric field, a transmission power level may be controlled so as to be larger than that under the environment having the weak electric field.

The television set 121 can receive easily a radio wave transmitted by the transmitter under the environment having a strong electric field with any method mentioned above.

The specific example of the AV apparatus 113 in each above mentioned embodiment may include a mobile phone, a personal handy phone (PHS: registered trademark), a personal digital assistant (PDA), a personal computer (PC), a video player, a video recorder, a digital video disk (DVD) player/recorder and a multi-media player.

Because an electric field of a broadcast radio wave is strong near a tower for transmitting a radio wave or the like, it is difficult for a radio wave of other wireless communication to reach a destination thereof. According to the method disclosed in Japanese Patent Application Laid-Open No. 2003-110475, the communication is carried out through a channel which has a null point. However, it is difficult to detect the proper null point under such radio wave environment near the tower. It is because that the null point detected under the environment having a strong electric field does not always have a thoroughly weak electric field like the null point under the ideal environment. Therefore, the method disclosed in Japanese Patent Application Laid-Open No. 2003-110475 has a defect that the transmitted signal has a possibility to be caused the noise interference on transmitting a video signal and an audio signal through the channel which has the null point. Therefore, the disorder may occur in the video and audio signal regenerated by the receiver.

According to the embodiment of the present invention, the transmitter with two available antennas can transmit the radio wave in the form suitable for a surrounding electric field environment, because a channel for transmission of the AV signal, and an antenna to be used for transmission are selected through comparing electric field strength, which is measured on the basis of the received radio wave, with a predetermined threshold value. As a result, a television set can regenerate a clear image and clear sound even under the environment where it is difficult for the radio wave transmitted by the transmitter to reach the television set.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

Further, it is the inventor's intention to retain all equivalents of the claimed invention even if the claims are amended during prosecution.

What is claimed is:

1. A radio transmission system, comprising:
a transmitter transmitting a radio signal, comprising:
a first antenna;
a second antenna;
a transmission circuit converting an inputted signal into the radio signal corresponding to a transmission channel in a predetermined frequency band, and transmitting the radio signal via a transmission antenna;
a receiving circuit measuring an electric field strength, for each channel, of a radio wave which a receiving antenna receives;
a control circuit selecting the first antenna as the receiving antenna, detecting the largest value and the smallest value out of the electric field strength, selecting a channel which includes the smallest value of the electric field strength as the transmission channel, selecting the first antenna as the transmission antenna when the largest value is equal to or smaller than a predetermined threshold value, and selecting the second antenna as the transmission antenna when the largest value is larger than the predetermined threshold value; and
a switching circuit connecting the transmission circuit to one of the first antenna and the second antenna, and connecting the receiving circuit to one of the first antenna and the second antenna according to the selection by the control circuit; and
a receiver receiving the radio signal.

2. The radio transmission system according to claim 1, wherein
the control circuit selects the second antenna as the receiving antenna during transmitting the radio signal via the first antenna, detects the largest value of the electric field strength except for a radio wave of the transmission channel, and changes the transmission antenna from the first antenna to the second antenna when the largest value is larger than the predetermined threshold value.

3. The radio transmission system according to claim 2, wherein
the control circuit selects the first antenna as the receiving antenna during transmitting the radio signal via the second antenna, detects the largest value of the electric field strength except for a radio wave of the transmission channel, and changes the transmission antenna from the second antenna to the first antenna as the transmission antenna when the largest value is larger than the predetermined threshold value.

4. The radio transmission system according to claim 1, further comprising:
a signal generating circuit generating an internal signal corresponding to a plurality of channels of the frequency band, and transmitting the internal signal via the first antenna, wherein
the control circuit selects the second antenna as the receiving antenna during transmitting the internal signal via the first antenna, and selects a channel including the smallest value of the electric field strength as the transmission channel, and
the switching circuit changes connection of the signal generating circuit according to selection of the control circuit.

5. The radio transmission system according to claim 1, further comprising:
an antenna detection circuit determining whether or not the second antenna is connected with the transmitter, wherein
the control circuit selects the first antenna as the transmission antenna, when the second antenna is not connected with the transmitter.

6. The radio transmission system according to claim 5, wherein
the control circuit selects the second antenna as the transmission antenna, when the second antenna is connected with the transmitter and the largest value is larger than the threshold value.

7. The radio transmission system according to claim 1, further comprising:
an amplifier amplifying an output signal of the transmitter with a gain set by the control circuit, wherein the control circuit sets a gain which is larger than a gain which is set when the largest value is equal to or smaller than the threshold value, when the largest value is larger than the threshold value.

8. The radio transmission system according to claim 1, further comprising:
an amplifier amplifying an output signal of the transmitter with a gain set by the control circuit, wherein
the control circuit sets a gain which is larger than a gain which is set when the transmitting antenna is the first antenna, when the transmitting antenna is the second antenna.

9. The radio transmission system according to claim 1, wherein
the second antenna is arranged in the closer vicinity of the receiver in comparison with the first antenna.

10. A radio transmission system, comprising:
a transmitter transmitting a radio signal, comprising:
a first antenna;
a second antenna;
a transmitting means for converting an inputted signal into the radio signal corresponding to a transmission channel in a predetermined frequency band, and transmitting the radio signal via a transmission antenna;
a receiving means for measuring an electric field strength, for each channel, of a radio wave which a receiving antenna receives;
a control means for selecting the first antenna as the receiving antenna, detecting the largest value and the smallest value out of the electric field strength, selecting a channel which includes the smallest value of the electric field strength as the transmission channel, selecting the first antenna as the transmission antenna when the largest value is equal to or smaller than a predetermined threshold value, and selecting the second antenna as the transmission antenna when the largest value is larger than the predetermined threshold value; and
a switching means for connecting the transmitting means to one of the first antenna and the second antenna, and connecting the receiving means to one of the first antenna and the second antenna according to the selection by the control means; and
a receiver receiving the radio signal.

11. A transmitter transmitting a radio signal, comprising:
a first antenna;
a second antenna;
a transmission circuit converting an inputted signal into the radio signal corresponding to a transmission channel in a predetermined frequency band, and transmitting the radio signal via a transmission antenna;
a receiving circuit measuring an electric field strength, for each channel, of a radio wave which a receiving antenna receives;
a control circuit selecting the first antenna as the receiving antenna, detecting the largest value and the smallest value out of the electric field strength, selecting a channel which includes the smallest value of the electric field strength as the transmission channel, selecting the first antenna as the transmission antenna when the largest value is equal to or smaller than a predetermined threshold value, and selecting the second antenna as the transmission antenna when the largest value is larger than the predetermined threshold value; and
a switching circuit connecting the transmission circuit to one of the first antenna and the second antenna, and connecting the receiving circuit to one of the first antenna and the second antenna according to the selection by the control circuit.

12. The transmitter according to claim 11, wherein
the control circuit selects the second antenna as the receiving antenna during transmitting the radio signal via the first antenna, detects the largest value of the electric field strength except for a radio wave of the transmission channel, and changes the transmission antenna from the first antenna to the second antenna when the largest value is larger than the predetermined threshold value.

13. The transmitter according to claim 12, wherein
the control circuit selects the first antenna as the receiving antenna during transmitting the radio signal via the second antenna, detects the largest value of the electric field strength except for a radio wave of the transmission channel, and changes the transmission antenna from the second antenna to the first antenna as the transmission antenna when the largest value is larger than the predetermined threshold value.

14. The transmitter according to claim 11, further comprising:
a signal generating circuit generating an internal signal corresponding to a plurality of channels of the frequency band, and transmitting the internal signal via the first antenna, wherein
the control circuit selects the second antenna as the receiving antenna during transmitting the internal signal via the first antenna, and selects a channel including the smallest value of the electric field strength as the transmission channel, and
the switching circuit changes connection of the signal generating circuit according to selection of the control circuit.

15. The transmitter according to claim 11, further comprising:
an antenna detection circuit determining whether or not the second antenna is connected with the transmitter, wherein
the control circuit selects the first antenna as the transmission antenna, when the second antenna is not connected with the transmitter.

16. The transmitter according to claim 15, wherein
the control circuit selects the second antenna as the transmission antenna, when the second antenna is connected with the transmitter and the largest value is larger than the threshold value.

17. The transmitter according to claim 11, further comprising:
an amplifier amplifying an output signal of the transmitter with a gain set by the control circuit, wherein
the control circuit sets a gain which is larger than a gain which is set when the largest value is equal to or smaller than the threshold value, when the largest value is larger than the threshold value.

18. The transmitter according to claim 11, further comprising:
an amplifier amplifying an output signal of the transmitter with a gain set by the control circuit, and wherein
the control circuit sets a gain which is larger than a gain which is set when the transmitting antenna is the second antenna, when the transmitting antenna is the first antenna.

19. The transmitter according to claim 11, wherein
the second antenna is arranged in the closer vicinity of the receiver in comparison with the first antenna.

20. A transmitter transmitting a radio signal, comprising:
a first antenna;
a second antenna;
a transmission means for converting an inputted signal into the radio signal corresponding to a transmission channel in a predetermined frequency band, and transmitting the radio signal via a transmission antenna;
a receiving means for measuring an electric field strength, for each channel, of a radio wave which a receiving antenna receives;
a control means for selecting the first antenna as the receiving antenna, detecting the largest value and the smallest value out of the electric field strength, selecting a channel which includes the smallest value of the electric field strength as the transmission channel, selecting the first antenna as the transmission antenna when the largest value is equal to or smaller than a predetermined threshold value, and selecting the second antenna as the transmission antenna when the largest value is larger than the predetermined threshold value; and
a switching means for connecting the transmission means to one of the first antenna and the second antenna, and connecting the receiving means to one of the first antenna and the second antenna according to the selection by the control means.

21. A program which executes a computer in the control circuit of the transmitter according to claim 11, wherein
a control circuit includes a memory device which stores the program, and
the computer reads the program and executes the read program.

22. A recording medium which can be read by the computer and stores the program according to claim 21.

23. A radio transmission method, comprising:
selecting a receiving antenna;
measuring electric field strength of a radio wave which the receiving antenna receives, for each channel;
detecting the largest value and the smallest value out of the measured electric field strength;
selecting a channel including the smallest value of the electric field strength as a transmission channel;
selecting the first antenna as a transmission antenna if the largest value is equal to or smaller than a predetermined threshold value, and selecting the second antenna as the transmission antenna if the largest value is larger than or equal to the predetermined threshold value;
converting an inputted signal into a radio signal corresponding to the transmission channel; and
transmitting the radio signal via the transmission antenna.

24. The radio transmission method according to claim 23, further comprising:
selecting the second antenna as a receiving antenna during transmitting the radio signal via the first antenna;
detecting the largest value of electric field strength of a received radio wave except for a radio wave of the transmission channel; and
changing the transmission antenna from the first antenna to the second antenna as the transmission antenna when the largest value is larger than or equal to the threshold value.

25. The radio transmission method according to claim 24, further comprising:
selecting the first antenna as a receiving antenna during transmitting the radio signal via the second antenna; and
changing the transmission antenna from the second antenna to the first antenna as the transmission antenna when the largest value is larger than or equal to the threshold value.

26. The radio transmission method according to claim 23, further comprising:
generating an internal signal corresponding to a plurality of channels of the frequency band;
transmitting the internal signal via the first antenna,
selecting the second antenna as the receiving antenna during transmitting the internal signal via the first antenna; and
selecting a channel including the smallest value of the electric field strength as the transmission channel.

27. The radio transmission method according to claim 23, further comprising:
determining whether or not the second antenna is available; and
transmitting the radio signal via the first antenna when the second antenna is not available.

28. The radio transmission method according to 27, further comprising:
transmitting the radio signal via the second antenna, when the second antenna is available and the largest value is larger than the threshold value.

29. The radio transmission method according to claim 23, further comprising:
transmitting the radio signal with a power of a signal higher than a power of a signal which is transmitted when the largest value is equal to or smaller than the threshold value, when the largest value is larger than the threshold value.

30. The radio transmission method according to claim 23, further comprising:
transmitting the radio signal with a power of a signal higher than a power of a signal which is transmitted when the transmission antenna is the second antenna, when the transmission antenna is the second antenna.
